(19) United States
(12) Patent Application Publication
(10) Pub. No.: US 2007/0086031 A1
(43) Pub. Date: Apr. 19, 2007

(54) Printer having a direct printing function and printing method thereof

(76) Inventor: Guang Ming Li, Suwon-si (KR)

Correspondence Address: STANZIONE & KIM, LLP, 919 18TH STREET, N.W., SUITE 440, WASHINGTON, DC, 20006, US

(21) Appl. No.: 11/431,838

(22) Filed: May 11, 2006

(30) Foreign Application Priority Data
Oct. 18, 2005 (KR) 2005-98322

(51) Int. Cl. G06K 15/02

(52) U.S. Cl. 358/1.11; 358/1.13

(57) ABSTRACT

A printer having a direct printing function and a printing method thereof include memory that stores font information about an embedded font type, a font processor that compares font information embedded in a PDF file with the font information stored in the memory, and determines which font information embedded in the PDF file is converted into a postscript (PS) based on the comparison result, a PDF converter that converts the font information, which is determined by the font processor to be converted into the PS, and a resource of the PDF file into the PS, and a PS interpreter that converts a font of the PDF file into a bitmap data based on one of the font information stored in the memory and the font information embedded in the PDF file which is converted into the PS by the PDF converter. Accordingly, a conversion process from the PDF file into the PS and bitmap data can be simplified time taken for the conversion can be reduced, and thus, the print performance of the printer is improved.

### CROSS-REFERENCE TO RELATED APPLICATIONS

This application claims benefit under 35 U.S.C. § 119 from Korean Patent Application No. 2005-98322, filed on Oct. 18, 2005, the entire content of which is incorporated herein by reference.

### BACKGROUND OF THE INVENTION

1. Field of the Invention

The present general inventive concept relates to a printer having a direct printing function and a printing method thereof. More particularly, the present general inventive concept relates to a printer having a direct printing function, which is capable of reducing a time taken for conversion of font information and simplifying a process of converting the font information when directly printing a portable document format (PDF), and a printing method thereof.

2. Description of the Related Art

A PDF is a file format that is created by an Acrobat program developed by Adobe. The Acrobat program has capabilities of capturing document images from an original document having an original format and outputting images in a format that is faithful to the original format, and so it is suitable to make an electronic brochure which is designed to be viewed through a document or a monitor.

In order to print such a PDF file, a conventional method converts a PDF file into a print language such as post script (PS) using a printer driver before transmitting the PDF file from a hard disk of a PC to a printer through a network.

However, as a size of the PDF file becomes larger, it takes a large amount of time for the PC to convert the PDF file into print data and also a complicated process is required to do so. Also, the print data becomes larger after it is converted and thus it takes a large amount of time to transmit the print data. Therefore, an excessive load is exerted to the PC. In order to mitigate the load exerted to the PC, a printer having a PDF direct printing function has been suggested. The printer having the PDF direct printing function has capability of directly printing the PDF file transmitted from the PC without converting it.

More specifically, the PDF file is directly transmitted to the printer without using a printer driver, and a PDF interpreter provided in the printer converts the PDF file into bitmap data such that the printer can print the bitmap data. The PDF direct printing is advantageous over other printings using the printer driver because it does not cause the print data to be larger when transmitting the print data to the printer.

A conventional PDF direct printing operation will now be described in detail with reference to FIG. 1.

When a PDF file to be printed is transmitted from a PC to a printer, the printer converts and prints the PDF file by performing two operations as follows.

First, the printer converts the PDF file into a PS, converts the PS into a bitmap data and then prints the bitmap data.

The process of converting the PDF file into the PS is divided into a resource setting process and a page setting process. The resource setting process converts a resource included in the PDF file into the PS at operation S100, and the page setting process converts a page type of the PDF file into a PS page type based on information included in the PDF file at operation S110. During the resource setting process, font information is converted into the PS because a font type supported by the PDF is different from that supported by the PS. Accordingly, the printer decodes the font information included in the PDF file and then encodes it according to a PS format.

After the PDF file is converted into the PS, the PS interpreter converts print data converted into the PS into the bitmap data at operations S120, S130, and S140. At this time, it is determined whether there is a font identical to the font included in the print data in a PS code. If there is the identical font, the PS interpreter selects the identical font, and if not, the PS interpreter searches for the identical font from a font list stored in the printer. If there is the identical font in the font list, the identical font is selected, and if not, the PS interpreter converts the print data using a most similar font to the font included in the print data. And, the printer prints an error message informing a user of that there is a problem with the font.

As described above, the conventional PDF direct printing function converts the font information included in the PDF file into the PS. The font information includes information about the font type and how to print the font. Therefore, if all the font information is converted into the PS, due to its large size, it requires a large amount of time and a complicated process for the conversion. Especially, in case a of a Chinese language kit “CJK” font about Korean, Japanese, Chinese, since each letter is constituted of 2 bit or more long, the size of the converted PS code is larger. Therefore, a more complicated process is required to encode the CJK font, and the time required for the conversion at the PS interpreter inevitably increases.

### SUMMARY OF THE INVENTION

The present general inventive concept provides a printer with a direct printing function which is capable of reducing a time taken for conversion of font information and simplifying a process of converting the font information when directly printing a PDF, and a printing method thereof.

Additional aspects and advantages of the present general inventive concept will be set forth in part in the description which follows and, in part, will be obvious from the description, or may be learned by practice of the general inventive concept.

The foregoing and/or aspects of the present general inventive concept may be achieved by providing a printer having a PDF direct printing function, the printer including a memory that stores font information about an embedded font type, a font processor that compares font information embedded in a PDF file with the font information stored in the memory, and determines which font information embedded in the PDF file is converted into a postscript (PS) based on the comparison result, a PDF converter that converts the font information, which is determined by the font processor to be converted into the PS, and a resource of the PDF file into the PS, and a PS interpreter that converts a font of the PDF file into a bitmap data based on one of the font information stored in the memory and the font information embedded in the PDF file which is converted into the PS by the PDF converter.

The font information may include a font name and a font encoding which is information necessary to realize the font.

The font processor may determine if a font name embedded in the PDF file exists in the memory, and if the font name of the PDF file does not exist in the memory, determines if a font encoding corresponding to the font name of the PDF file exists in the PDF file.

If the font name embedded in the PDF file exists in the memory and the font encoding does not exist in the PDF file, the PDF converter may convert only the font name into the PS, and, if the font encoding exists in the PDF file, the PDF converter converts the font encoding into the PS.

The printer may further include a mark memory that stores the font name embedded in the PDF file and a mark that matches the font name according to a determination of whether the font information corresponding to the font name exists in the memory or the PDF file.

The font processor may search the font name embedded in the PDF file, matches the searched font name with a first mark and stores the matching result.

If the font name embedded in the PDF file exists in the memory, the font processor may convert the first mark matching the font name into a second mark and stores the converted mark in the mark memory. If the font encoding corresponding to the font name embedded in the PDF file exists in the PDF file, the font processor may convert the first mark matching the font name into a third mark and stores the converted mark in the mark memory.

If the font name embedded in the PDF file does not exist in the memory and the font encoding corresponding to the font name embedded in the PDF file does not exist in the PDF file, the font processor may convert the first mark matching the font name into a fourth mark and stores the converted mark in the mark memory.

When a font name matches the second mark, the PS interpreter may extract the font information corresponding to the font name from the memory and may convert the extracted font information into bitmap data. When a font name matches the third mark, the PS interpreter may extract the font encoding included in the PDF file and converted into the PS, and converts the extracted font encoding into the bitmap data. When a font name matches the fourth mark, the PS interpreter may select a font type most similar to the font name from the memory and may convert the selected font type into a bitmap data.

The printer may further include a controller that displays an error message if the most similar font type is selected and converted into the bitmap data.

The foregoing and/or other aspects of the present general inventive concept may also be achieved by providing a method of directly printing a PDF file, the method including searching a font name included in the PDF file, comparing the searched font name with font information included in a printer, determining which font information included in the PDF file is converted into a PS based on the comparison result, converting the font information, which is determined to be converted into the PS, and a resource of the PDF file into the PS, and converting a font of the PDF file into bitmap data based on at least one of the font information included in the printer and the font information embedded in the PDF file and converted into the PS.

The foregoing and/or other aspects of the present general inventive concept may also be achieved by providing an image forming system including a font processor to detect a font name of a PDF file, a PDF converter to convert the detected font name of the PDF file into a post script, and a PS interpreter to convert a font of the PDF file into bitmap data according to the postscript.

The foregoing and/or other aspects of the present general inventive concept may also be achieved by providing an image forming system including a memory to store one or more marks corresponding to states of a PDF file according to a font name and a font encoding included in the PDF file; and a font processor to detect the one or more marks to correspond to the PDF file, a PDF converter to convert a predetermined portion of the PDF file into a post script according to the detected one or more marks, a PS interpreter to convert the PDF file into bitmap data according to the post scrip, and a printing unit to directly print the PDF file with the bitmap data.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a flowchart illustrating a conventional PDF file direct printing operation;

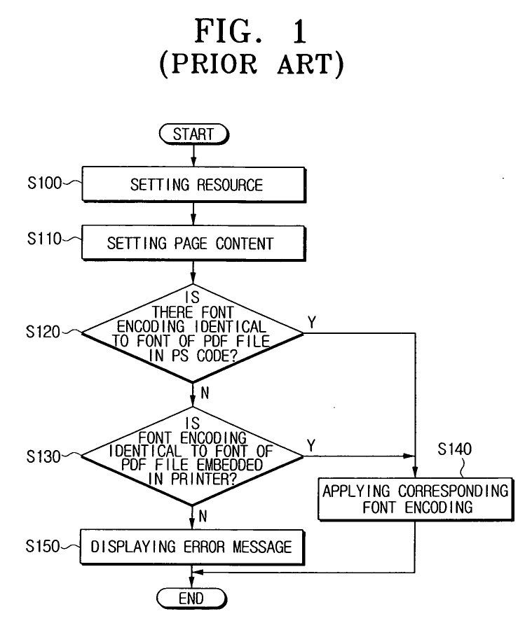

FIG. 2 is a block diagram illustrating a printer having a PDF file direct printing function according to an embodiment of the present general inventive concept; and

FIG. 3 is a flowchart illustrating a PDF file direct printing operation according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A PDF file typically includes four sections, i.e., a header, a body, a cross reference table, and a trailer. The body contains a series of objects and a resource such as font information. The font information includes a font name indicating a font type and a font encoding indicating a method of realizing the font type. Only one of the font name and the font encoding may be embedded in the PDF file, or both the font name and the font encoding are not embedded in the PDF file.

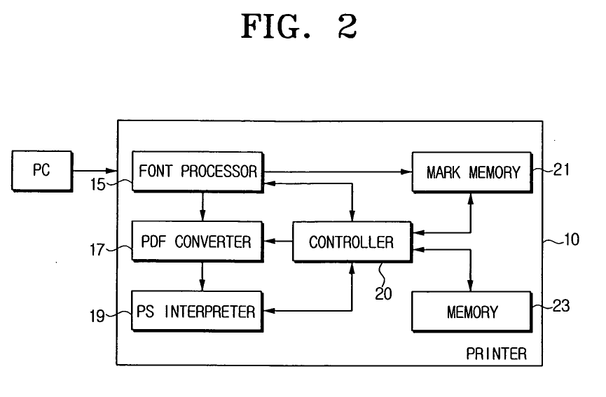

FIG. 2 is a block diagram illustrating an image form apparatus, for example, a printer 10 having a PDF file direct printing function according to an embodiment of the present general inventive concept. As illustrated in FIG. 2, the printer 10 includes a font memory 23, a mark memory 21, a font processor 15, a PDF converter 17, a PS interpreter 19, and a controller 20. The printer 10 may be connected to a host, for example, a personal computer (PC) to receive data including image data which is formed in the PDF file. The printer 10 includes a printing unit to print the image data.

The font memory 23 stores a font list supportable by the printer 10 and detailed information necessary to realize each font.

The mark memory 21 stores therein font names embedded in the PDF file and marks that match with the font names according to a determination of whether there is a font in the font memory 23 or the PDF file that is identical to a font type corresponding to each font name embedded in the PDF file. For example, with respect to all the font names embedded in the PDF file, a first mark ‘0’ is initially matched (set or assigned) to the respective font names and stored in the mark memory 21. If the font type corresponding the font name embedded in the PDF file exists in the font memory 23, the first mark “0” of the font name is converted into a second mark ‘1’ and is stored. If a font encoding corresponding to the font name exists in the PDF file, the first mark ‘0’ of the font name is converted into a third mark ‘2’ and stored in the mark memory 21, and if there is no font encoding in the PDF file, the first mark ‘0’ of the font name is converted into a fourth mark ‘3’ and stored in the mark memory 21. The definitions of the marks with respect to the font names may be changed according to a user preference corresponding to the font name, the font type, the font encoding, and so on.

The font processor 15 matches the font names with the marks according to a determination of whether the font encoding corresponding to the font name embedded in the PDF file is included in the PDF file and whether the font name embedded in the PDF file exists in the font memory 23 of the printer 10, and stores the matching result in the mark memory 21. That is, the marks are assigned to the respective font names according to the above determinations. The font processor 15 provides information on the matching result to the PDF converter 17.

More specifically, the font processor 15 searches font names of all the fonts embedded in the body of the PDF file when receiving the PDF file from the PC. The font processor 15 uses a key word ‘BaseFont’ to search the font names. The font processor 15 matches the font names with a mark and stores the matching result. The mark is assigned to a corresponding font name. An initial value of the mark matching all the font names is initially set to ‘0.’

The font processor 15 determines whether the searched font names are stored in the font memory 23 of the printer 10. If the font names embedded in the PDF file exist in the font memory 23 of the printer 10, the font processor 15 provides information to realize a font to the PDF converter 17. In this case, since it is possible for the printer 10 to print a corresponding font type, the PDF converter 17 converts only the corresponding font name into the PS. The font processor 15 converts the mark ‘0’ matching the corresponding font name, which is stored in the mark memory 21, into the second mark ‘1’ and stores the converted second mark ‘1’ in the mark memory 21. That is, the printer 10 may print the PDF file with the corresponding font type using the PS of the corresponding font name according to the determination of whether the corresponding font name is stored in the font memory 23. It is possible that a second PDF file may be printed using the PS of the corresponding font name according to the second mark ‘1.’

If the searched font names do not exit in the font memory 23, the font processor 15 determines whether a font encoding is embedded in the PDF file. To do so, the font processor 15 uses keywords such as ‘FontDescriptor’ and ‘FontFile/FontFile2/FontFile3.’ The keyword ‘FontDescriptor’ specifies a matrix and other features of the font, and the font encoding is recorded as ‘FontFile/FontFile2/FontFile3.’ If the font encoding is embedded in the PDF file, the PDF file is printable using the corresponding font encoding, and the font processor 15 provides the font encoding to the PDF converter 17. The PDF converter 17 decodes the font encoding and converts the decoded font encoding into the PS. For example, a font type 1C of the PDF file is converted into a font type 1 of the PS, and a true type font of the PDF file is converted into a font type 42 of the PS. The font processor 15 converts the mark of the font name stored in the mark memory 21 into the third mark “2” and stores the converted third mark “2.”

If no font encoding is embedded in the PDF file, since the corresponding font type is not supportable by both the printer 10 and the PDF file, the printing operation is not performed with an accurate font. In this case, the font processor 15 converts the mark of the corresponding font name stored in the mark memory 21 into the fourth mark ‘3’ and stores the converted fourth mark “3.”

The PDF converter 17 may convert the PDF file into the PS, converts the resource included in the PDF file into the PS, and convert each page of the PDF file into a page of a PS format. The PDF converter 17 may convert the font information into the PS when converting the resource thereof. At this time, the PDF converter 17 may convert all the font information into the PS or convert only the corresponding font name among all font information into the PS according to the determination of the font processor 15.

More specifically, the PDF converter 17 converts only the font name into the PS if the mark matching the font name is ‘1,’ i.e., if the font name exists in the font memory 23. If the mark matching the font name is ‘2,’ i.e., if the font name does not exist in the font memory 23 and the font encoding is embedded in the PDF file, the PDF converter 17 converts all the font information including the font name and the font encoding embedded in the PDF file into the PS. If the mark matching the font name is ‘3,’ i.e., if no font name exist in the font memory 23 and no font encoding exist in the PDF file, the PDF file converter 17 converts only the font name or a font name similar to the font name matching the fourth mark ‘3,’ into the PS.

After converting the resource including the font into the PS, the PDF converter 17 sets each page of the PDF file according to a format of the PS.

The PS interpreter 19 converts the print data of the PDF file, which is converted into the PS, into the bitmap data. The PS interpreter 19 refers to the mark memory 21 to convert a font included in the PS into the bitmap data. For example, with respect to a font matching the mark “1” stored in the mark memory 21, the PS interpreter 19 extracts font information about a corresponding font type from the font memory 23 and applies the font to a corresponding position. With respect to a font matching the mark “2” stored in the mark memory 21, the PS interpreter 19 converts a font encoding included in the print data, which is converted into the PS, into the bitmap data and applies the font according to the corresponding font encoding. With respect to a font matching the mark “3” stored in the mark memory 21, the PS interpreter 19 extracts a font most similar to the font name embedded in the PDF file from the font memory 23 and applies the font to a corresponding position.

The controller 20 controls data input and output of the mark memory 21 and the font memory 23 and operations of the font processor 15, the PDF converter 17 and the PS interpreter 19.

If the font information corresponding to the font name embedded in the PDF file does not exist in the font memory, and the font encoding of the font name is not embedded in the PDF file, the controller 20 displays an error message on the printer 10 or the PC to inform a user that the print data is not printed with the font the user wants to use.

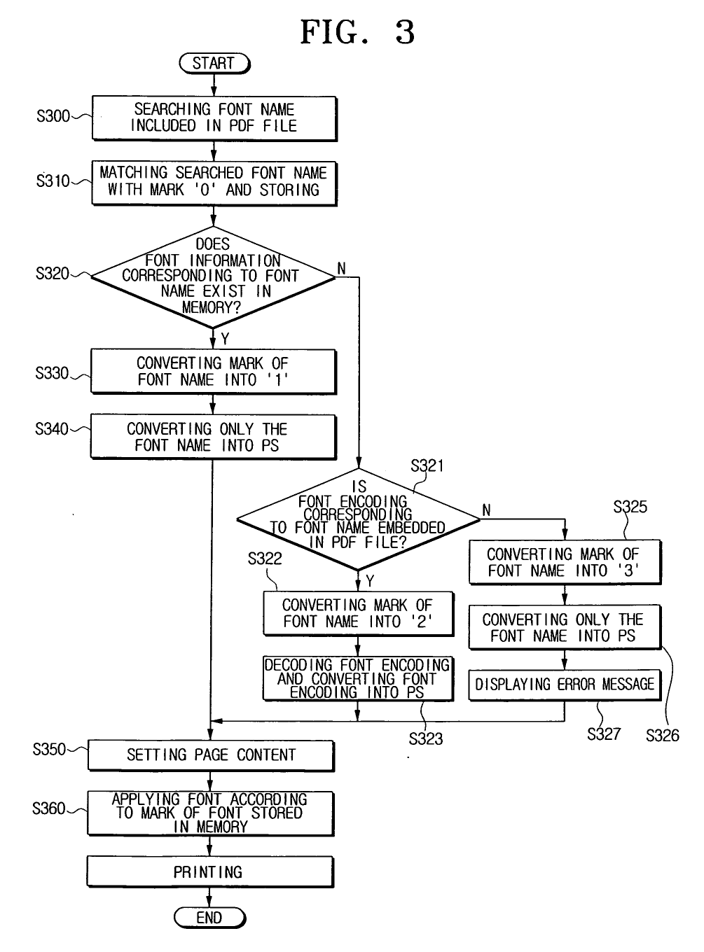

An operation of printing the PDF file of the printer 10 will now be described with reference to FIG. 3 hereinbelow.

Referring to FIGS. 2 and 3, if a user inputs a command to print a PDF file, a PC transmits the PDF file to the printer 10.

The controller 20 of the printer 10 operates the font processor 15 upon receiving the PDF file, and the font processor 15 searches all the font names embedded in the PDF file at operation S300. The searched font names are matched with the mark ‘0’ and then stored in the mark memory 21 at operation S310. The font processor 15 determines whether font information corresponding to the searched font names is stored in the font memory 23 at operation S320.

If the font information corresponding to the searched font name is stored in the font memory 23 at operation S320, the font processor 15 provides the result of determination to the PDF converter 17 and converts the mark ‘0’ of the corresponding font name stored in the font memory 23 into the mark ‘1’ at operation S330. If the font information corresponding to the font names does not exist in the font memory 23 at operation S320, the font processor 15 determines whether a font encoding exists in the PDF file at operation S321.

If a font encoding exists in the PDF file at operation S321, the font processor 15 converts the mark of the corresponding font name stored in the mark memory 21 into the mark ‘2’ at operation S322.

If no font encoding exist in the PDF file at operation S321, the font processor 14 converts the mark of the corresponding font name stored in the mark memory 21 into the mark ‘3’ at operation S325. The font processor 15 provides the determination to the PDF converter 17.

The PDF converter 17 converts the font name or the font encoding according to the determination provided by the font processor 15. The PDF converter 17 converts only the font name with respect to a font matching the mark ‘1’ and a font matching the mark ‘3’ into PS at operations S340 and 326, and decodes the font encoding included in the PDF file with respect to a font matching the mark ‘2’ and converts it into PS at operation S323.

At this time, the controller 20 displays an error message if a font matches the mark ‘3’ at operation S327.

If the conversion of the resource including the font into the PS is completed, the PDF converter 17 converts a page and a content of the PDF file into the PS at operation S350.

If the PDF file is converted into the PS, the PS interpreter 19 converts print data, which is converted into the PS, into bitmap data, and applies a font of the print data by referring to the mark of each font stored in the mark memory 21 at operation S360.

If a font name matches the mark ‘1’ stored in the mark memory 21, the PS interpreter 19 extracts font information corresponding to the font name from the font memory 23 and applies a corresponding font. On the other hand, if the font name matches the mark 2 stored in the mark memory, the PS interpreter 19 converts the font encoding extracted from the PDF file into the bitmap data and applies the font according to the font. Finally, if a font matches the mark ‘3’ stored in the mark memory 21, the PS interpreter 19 extracts a font most similar to the corresponding font from the font memory 23 and applies the most similar font to a corresponding position.

If the conversion of the print data into the bitmap data is completed, the controller 20 controls to perform a printing operation.

As described above, in the PDF file direct printing operation, the printer 10 converts only the font name into the PS if the font information corresponding to the font name embedded in the PDF file is stored in the font memory 23. Accordingly, the process of converting the PDF file into the PS and the PS into the bitmap data becomes simplified and a time required for the conversion can be reduced. Especially, a large amount of time taken for the conversion of a big size font such as CJK fonts can be reduced, and thus, the print performance of the printer is improved.

According to the present general inventive concept as described above, the conversion process from the PDF file into the PS and the bitmap data can be simplified and the time taken for the conversion can be reduced, so the print performance of the printer is improved.

According to the present general inventive concept as described above, an image forming system includes a font processor to detect a font name of a PDF file, a PDF converter to convert the detected font name of the PDF file into a post script, and a PS interpreter to convert a font of the PDF file into bitmap data according to the postscript. The image forming system may further include a printing unit to print the PDF file according to the bitmap data. The font processor may detect a font encoding of the PDF file, the PDF converter may convert the detected font encoding of the PDF file into a second post script, and the PS interpreter may convert the font of the PDF file into the bitmap data according to the second postscript. Here, the PDF file may include a body having objects and a resource including font information on the font, and the PPD converter may not convert all of the PDF file into the post script. It is possible that the image forming system further includes a memory to store font information, and a controller to generate a message representing that the PDF file is not printed with the font of the PDF file, when the font processor does not detect the font name of the PDF file from the font information of the memory. It is also possible that the image forming system includes a memory to store font information, and a controller to control the PDF converter to convert a second font name corresponding to the font name into the post script when the font processor does not detect the font name of the PDF file from the font information of the memory.

According to the present general inventive concept as described above, an image forming system may include a memory to store one or more marks corresponding to states of a PDF file according to a font name and a font encoding included in the PDF file, a font processor to detect the one or more marks to correspond to the PDF file, a PDF converter to convert a predetermined portion of the PDF file into a post script according to the detected one or more marks, a PS interpreter to convert the PDF file into bitmap data according to the post scrip, and a printing unit to directly print the PDF file with the bitmap data.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image forming apparatus, comprising:
a memory that stores font information about an embedded font type;
a font processor that compares font information embedded in a PDF file with the font information stored in the memory, and determines which font information embedded in the PDF file is converted into a postscript (PS) based on the comparison result;
a PDF converter that converts the font information, which is determined by the font processor to be converted into the PS, and a resource of the PDF file into the PS; and
a PS interpreter that converts a font of the PDF file into bitmap data based on one of the font information stored in the memory and the font information embedded in the PDF file which is converted into the PS by the PDF converter.

2. The apparatus as claimed in claim 1, wherein the font information comprises a font name and a font encoding which is information necessary to realize the font.

3. The apparatus as claimed in claim 2, wherein the font processor determines if the font name embedded in the PDF file exists in the memory, and if the font name of the PDF file does not exist in the memory, determines if the font encoding corresponding to the font name of the PDF file exists in the PDF file.

4. The apparatus as claimed in claim 3, wherein, if the font name embedded in the PDF file exists in the memory and a font encoding does not exist in the PDF file, the PDF converter converts only the font name into the PS, and, if a font encoding exists in the PDF file, the PDF converter converts the font encoding into the PS.

5. The apparatus as claimed in claim 1, further comprising:
a mark memory that stores a font name embedded in the PDF file and a mark that matches the font name according to whether font information corresponding to a determination of the font name exists in the memory or the PDF file.

6. The apparatus as claimed in claim 5, wherein the font processor searches the font name embedded in the PDF file, compares the searched font name with a first mark and stores the comparison result.

7. The apparatus as claimed in claim 6, wherein;
if the font name embedded in the PDF file exists in the memory, the font processor converts the first mark matching the font name into a second mark and stores the converted mark in the mark memory;
if a font encoding corresponding to the font name embedded in the PDF file exists in the PDF file, the font processor converts the first mark matching the font name into a third mark and stores the converted mark in the mark memory; and
if the font name embedded in the PDF file does not exist in the memory and a font encoding corresponding to the font name embedded in the PDF file does not exist in the PDF file, the font processor converts the first mark matching the font name into a fourth mark and stores the converted mark in the mark memory.

8. The apparatus as claimed in claim 7, wherein:
when the font name matches the second mark, the PS interpreter extracts the font information corresponding to the font name from the memory and converts the extracted font information into the bitmap data;
when the font name matches the third mark, the PS interpreter extracts the font encoding included in the PDF file and converted into the PS, and converts the extracted font encoding into the bitmap data; and
with respect to a font name matching the fourth mark, the PS interpreter selects a font type most similar to the font name from the memory and converts the selected font type into bitmap data.

9. The apparatus as claimed in claim 8, further comprising a controller that displays an error message if the most similar font type is selected and converted into the bitmap data.

10. A method of directly printing a PDF file, comprising:
searching a font name included in the PDF file;
comparing the searched font name with font information included in an image forming apparatus;
determining which font information included in the PDF file is converted into a PS based on the comparison result;
converting the font information, which is determined to be converted into the PS, and a resource of the PDF file into the PS; and
converting a font of the PDF file into bitmap data based on at least one of the font information included in the image forming apparatus and the font information embedded in the PDF file and converted into the PS.

11. The method as claimed in claim 10, wherein the font information includes a font name and a font encoding that is information necessary to realize the font.

12. The method as claimed in claim 11, wherein the comparing of the searched font name with the font information embedded in the printer in advance comprises determining whether the font name included in the PDF file exists in the image forming apparatus.

13. The method as claimed in claim 12, wherein the converting of the font information determined to be converted into the PS and the resource of the PDF file into the PS comprises converting only the font name into the PS if the font name included in the PDF file exists in the image forming apparatus.

14. The method as claimed in claim 12, further comprising:
determining whether a font encoding corresponding to the font name exists in the PDF file if the font name of the PDF file does not exist in the image forming apparatus.

15. The method as claimed in claim 14, wherein, if the font encoding exits in the PDF file, the converting of the font information determined to be converted into the PS and the resource of the PDF file into the PS comprises converting the font encoding included in the PDF file into the PS.

16. The method as claimed in claim 14, wherein, if the font encoding does not exist in the PDF file, the converting of the font information determined to be converted into the PS and the resource of the PDF file into the PS comprises converting the font name of the PDF file into the PS.

17. The method as claimed in claim 13, wherein the converting of the font of the PDF file into the bitmap data comprises extracting the font information corresponding to the font name from the image forming apparatus and converting the extracted font information into the bitmap data if the font name included in the PDF file exists in the image forming apparatus.

18. The method as claimed in claim 14, wherein the converting of the font of the PDF file into the bitmap data comprises extracting the font encoding included in the PDF file and converted into the bitmap data and converting the extracted font encoding into the bitmap data if the font encoding exists in the PDF file.

19. The method as claimed in claim 15, wherein the converting of the font of the PDF file into the bitmap data comprises selecting a font type most similar to the font name from the image forming apparatus and converting the most similar font type into the bitmap data if the font name included in the PDF file does not exist in the image forming apparatus and the font encoding corresponding to the font name included in the PDF file does not exist in the PDF file.

20. The method as claimed in claim 19, further comprising;
displaying an error message if the most similar font type is selected and converted into the bitmap data.

21. An image forming system comprising:
a font processor to detect a font name of a PDF file;
a PDF converter to convert the detected font name of the PDF file into a post script; and
a PS interpreter to convert a font of the PDF file into bitmap data according to the postscript.

22. The image forming system as claimed in claim 21, further comprising:
a printing unit to print the PDF file according to the bitmap data.

23. The image forming system as claimed in claim 21, wherein:
the font processor detects a font encoding of the PDF file;
the PDF converter converts the detected font encoding of the PDF file into a second post script; and
the PS interpreter converts the font of the PDF file into the bitmap data according to the second postscript.

24. The image forming system as claimed in claim 21, wherein the PDF file comprises a body having objects and a resource including font information on the font, and the PPD converter does not convert all of the PDF file into the post script.

25. The image forming system as claimed in claim 21, further comprising:
a memory to store font information; and
a controller to generate a message representing that the PDF file is not printed with the font of the PDF file, when the font processor does not detect the font name of the PDF file from the font information of the memory.

26. The image forming system as claimed in claim 21, further comprising:
a memory to store font information; and
a controller to control the PDF converter to convert a second font name corresponding to the font name into the post script when the font processor does not detect the font name of the PDF file from the font information of the memory.

27. An image forming system comprising:
a memory to store one or more marks corresponding to states of a PDF file according to a font name and a font encoding included in the PDF file;
a font processor to detect the one or more marks to correspond to the PDF file;
a PDF converter to convert a predetermined portion of the PDF file into a post script according to the detected one or more marks;
a PS interpreter to convert the PDF file into bitmap data according to the post scrip; and
a printing unit to directly print the PDF file with the bitmap data.
